(19) United States
(12) Patent Application Publication
(10) Pub. No.: US 2026/0337077 A1
(43) Pub. Date: Oct. 29, 2026

(54) ORGANIC WASTEWATER TREATMENT SYSTEM AND METHOD FOR TREATING ORGANIC WASTEWATER

(71) Applicant: INDUSTRIAL TECHNOLOGY RESEARCH INSTITUTE, Hsinchu (TW)

(72) Inventors: Jia-Hung WANG, Hsinchu City (TW); Wun-Jie HUANG, Taoyuan City (TW); Chun-Chi LEE, Hsinchu City (TW); Hsin-Ju HSIEH, Hsinchu City (TW); Shing-Der CHEN, Chiayi City (TW); Teh-Ming LIANG, Tainan City (TW)

(73) Assignee: INDUSTRIAL TECHNOLOGY RESEARCH INSTITUTE, Hsinchu (TW)

(21) Appl. No.: 19/439,800

(22) Filed: Jan. 5, 2026

(30) Foreign Application Priority Data
Apr. 29, 2025 (TW) 114116067

(51) Int. Cl. C02F 9/00; C02F 1/28; C02F 1/36; C02F 1/52; C02F 1/64; C02F 3/28; C02F 101/30

(52) U.S. Cl. CPC C02F 9/00; C02F 1/281; C02F 1/36; C02F 1/52; C02F 1/64; C02F 3/28; C02F 2101/30; C02F 2201/004; C02F 2209/02; C02F 2209/06

(57) ABSTRACT

A method for treating organic wastewater is provided. The method includes mixing a magnetic oxide material source with organic wastewater to form a first organic liquid; subjecting the first organic liquid to an ultrasonic treatment to produce a second organic liquid including magnetic nanoparticles of different sizes and a hydrolyzed sludge; subjecting the second organic liquid to a separation treatment to separate the magnetic nanoparticles into first magnetic nanoparticles and second magnetic nanoparticles according to particle size; and subjecting the hydrolyzed sludge to an anaerobic biological treatment using the second magnetic nanoparticles to convert the hydrolyzed sludge into methane. The first magnetic nanoparticles are recirculated to be mixed with the first organic liquid to continuously subject the first organic liquid to the ultrasonic treatment. Moreover, the magnetic oxide material source, the first and second magnetic nanoparticles each include at least magnetic iron oxide.

### CROSS REFERENCE TO RELATED APPLICATIONS

This Application claims priority of Taiwan Patent Application No. 114116067, filed on Apr. 29, 2025, the entirety of which is incorporated by reference herein.

### TECHNICAL FIELD

The present disclosure relates to an organic wastewater treatment system and a method for treating organic wastewater.

### BACKGROUND

The manufacturing industry contributes significantly to the global economy, but it also currently generates a large amount of waste. As the circular economy becomes mainstream, the issue of how to convert waste into resources and thereby reduce carbon emissions has gradually attracted the attention of both industry and government.

The manufacturing industry often generates a large amount of waste sludge during wastewater treatment. In light of demands for environmentally sustainable development, sludge from manufacturing industries, which contains a substantial amount of organic waste, is regarded as a recyclable and reusable resource. How to effectively treat and utilize this waste sludge has become an important issue for the manufacturing industry. Among existing sludge treatment technologies, physical pretreatment methods based on ultrasonic technology offer advantages in reducing environmental pollution, but they still face significant challenges in terms of power consumption.

As mentioned above, although existing waste sludge treatment technologies can generally meet their originally intended purposes, they still fail to fully meet the requirements in all respects. The development of effective and environmentally friendly technologies for sludge reduction and reuse in the treatment of organic wastewater has become a core issue in the manufacturing industry. Furthermore, the development of highly efficient and low-energy-consumption, low-carbon treatment technologies to achieve the resource utilization and energy recovery of waste sludge remains a topic of concern in related fields.

### SUMMARY

In accordance with some embodiments of the present disclosure, a method for treating organic wastewater is provided. The method includes (a) providing a magnetic oxide material source and mixing the magnetic oxide material source with organic wastewater to form a first organic liquid including the magnetic oxide material source and the organic wastewater. The method also includes (b) subjecting the first organic liquid to an ultrasonic treatment to produce a second organic liquid including magnetic nanoparticles of different sizes and a hydrolyzed sludge. The method also includes (c) subjecting the second organic liquid to a separation treatment to separate the magnetic nanoparticles of different sizes into first magnetic nanoparticles and second magnetic nanoparticles according to particle size. The first magnetic nanoparticles are recirculated to be mixed with the first organic liquid to continuously subject the first organic liquid to the ultrasonic treatment. The method further includes (d) subjecting the hydrolyzed sludge to an anaerobic biological treatment using the second magnetic nanoparticles to convert the hydrolyzed sludge into methane. Moreover, the magnetic oxide material source, the first magnetic nanoparticles, and the second magnetic nanoparticles each include at least magnetic iron oxide.

In accordance with some embodiments of the present disclosure, an organic wastewater treatment system is provided. The organic wastewater treatment system includes a feed unit, a magnetic oxide material source supply unit, an ultrasonic treatment unit, a separation unit, and an anaerobic biological treatment unit. The feed unit is used for providing organic wastewater. The magnetic oxide material source supply unit is connected to the feed unit. The magnetic oxide material source supply unit is used for providing a magnetic oxide material source to be mixed with the organic wastewater to form a first organic liquid. The first organic liquid includes the magnetic oxide material source and the organic wastewater. The ultrasonic treatment unit is connected to the feed unit. The ultrasonic treatment unit is used for subjecting the first organic liquid to an ultrasonic treatment to produce a second organic liquid. The second organic liquid includes magnetic nanoparticles of different sizes and a hydrolyzed sludge. The separation unit is connected to the ultrasonic treatment unit. The separation unit is used for separating the magnetic nanoparticles of different sizes into first magnetic nanoparticles and second magnetic nanoparticles according to particle size. The first magnetic nanoparticles are recirculated upstream of the ultrasonic treatment unit to be mixed with the first organic liquid to continuously subject the first organic liquid to the ultrasonic treatment. The anaerobic biological treatment unit is connected to the separation unit. The second magnetic nanoparticles in the anaerobic biological treatment unit are used for subjecting the hydrolyzed sludge to an anaerobic biological treatment to convert the hydrolyzed sludge into methane. Moreover, the magnetic oxide material source, the first magnetic nanoparticles, and the second magnetic nanoparticles each include at least magnetic iron oxide.

### BRIEF DESCRIPTION OF THE DRAWINGS

The present invention can be more fully understood by reading the subsequent detailed description and examples with references made to the accompanying drawings, wherein:

FIG. 1 shows a schematic diagram of an organic wastewater treatment system in accordance with some embodiments of the present disclosure;

FIG. 2 shows a flow chart of the steps of a method for treating organic wastewater in accordance with some embodiments of the present disclosure;

FIG. 3 shows the test results of the effect of the addition of magnetic iron oxide on the treatment efficiency of organic sludge in accordance with some embodiments of the present disclosure;

FIG. 4 shows the test results of the effect of the addition of magnetic iron oxide on the treatment efficiency of organic sludge in accordance with some embodiments of the present disclosure;

FIG. 5A shows the test results of the effect of the ultrasonic treatment unit on the particle nanonization of the magnetic iron oxide material source in accordance with some embodiments of the present disclosure;

FIG. 5B shows the test results of the effect of the ultrasonic treatment unit on the particle nanonization of the magnetic iron oxide material source in accordance with some embodiments of the present disclosure;

FIG. 6A shows the test results of the effect of nanonized magnetic iron oxide on the methane yield of the anaerobic biological treatment unit in accordance with some embodiments of the present disclosure;

FIG. 6B shows the test results of the effect of nanonized magnetic iron oxide on the methane yield of the anaerobic biological treatment unit in accordance with some embodiments of the present disclosure;

FIG. 7 shows the test results of the overall effect of adding the magnetic iron oxide material source on the methane yield of the organic wastewater treatment system in accordance with some embodiments of the present disclosure.

### DETAILED DESCRIPTION

The organic wastewater treatment system and the method for treating organic wastewater of the present disclosure are described in detail in the following description. It should be understood that the following description provides many different embodiments or examples for implementing different aspects of some embodiments of the present disclosure. The specific elements and configurations described in the following detailed description are set forth in order to clearly describe the present disclosure. It will be apparent that the exemplary embodiments set forth herein are used merely for the purpose of illustration and not the limitations of the present disclosure.

The embodiments of the present disclosure can be understood in conjunction with the accompanying drawings, which are also considered part of the disclosure. It should be understood that the drawings of the present disclosure are not drawn to scale and, in fact, the sizes of the components may be arbitrarily enlarged or reduced to clearly illustrate the features of the present disclosure.

As used herein, the phrase “a range between a first value and a second value” means that the range includes the first value, the second value, and other values therebetween.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In view of the demand for organic wastewater reduction faced by the current industry and the market demand for related technical products and services, embodiments of the present disclosure provide an organic wastewater treatment method capable of simultaneously improving sludge pretreatment efficiency and methane yield. By adding a magnetic oxide material source and combining it with the scheduling of the wastewater treatment process, the oxide coarse material source serves as an ultrasonic abrasive and as a biochemical metabolic catalyst at different stages of wastewater treatment. This synergistically enhances the existing ultrasonic sludge hydrolysis technology and the subsequent anaerobic biological metabolism for organic matter conversion, thereby achieving the effect of simultaneously improving sludge pretreatment efficiency and methane yield, and enabling the treatment of organic wastewater in a more energy-efficient and effective manner.

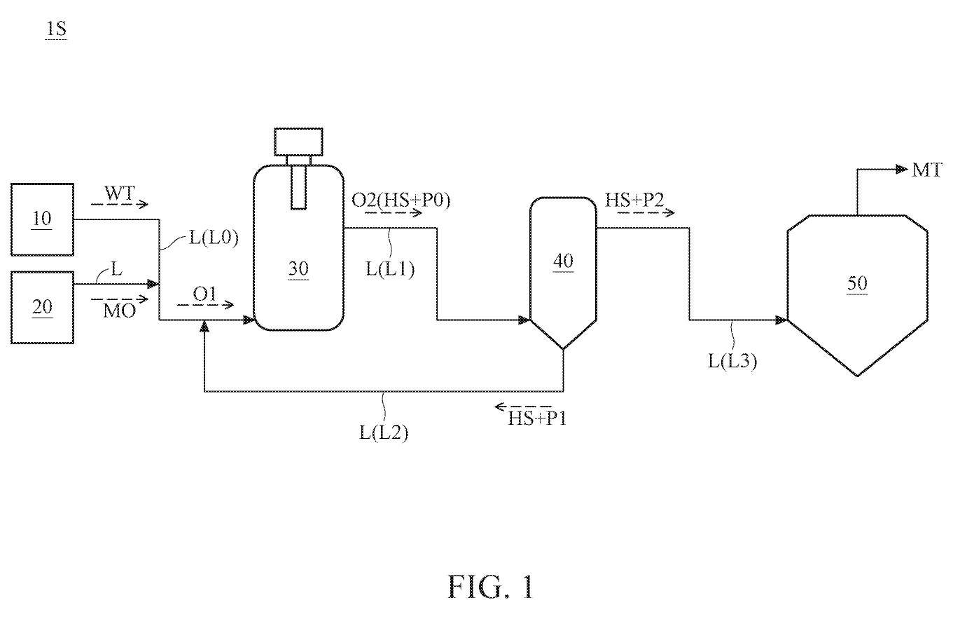

FIG. 1 shows a schematic diagram of an organic wastewater treatment system 1S in accordance with some embodiments of the present disclosure. It should be understood that for clarity of illustration, some components of the organic wastewater treatment system 1S are omitted in the figure and only schematically depicted. In accordance with some embodiments, additional features may be added to the organic wastewater treatment system 1S described below. The dotted arrows in the figure represent the direction of transport of materials between the units in the organic wastewater treatment system 1S.

Referring to FIG. 1, the organic wastewater treatment system 1S includes a feed unit 10, a magnetic oxide material source supply unit 20, an ultrasonic treatment unit 30, a separation unit 40, and an anaerobic biological treatment unit 50.

The feed unit 10 provides organic wastewater WT. The organic wastewater WT includes organic sludge. In accordance with some embodiments, the organic wastewater WT may include wastewater from the food industry, manufacturing industry, petrochemical industry, agriculture, livestock industry, wastewater containing organic matter from other sources, or a combination thereof, but it is not limited thereto.

The magnetic oxide material source supply unit 20 is connected to the feed unit 10. In accordance with some embodiments, the magnetic oxide material source supply unit 20 may be disposed downstream of the feed unit 10. In accordance with some other embodiments, the magnetic oxide material source supply unit 20 may be disposed upstream of the feed unit 10. The magnetic oxide material source supply unit 20 can provide a magnetic oxide material source MO and mix it with the organic wastewater WT to form a first organic liquid O1 including the magnetic oxide material source MO and the organic wastewater WT. The first organic liquid O1 may be a homogeneous organic liquid formed by mixing the magnetic oxide material source MO and the organic wastewater WT.

The magnetic oxide material source MO includes magnetic iron oxide. In accordance with some embodiments, the magnetic iron oxide may include magnetite (Fe₃O₄), ferrous oxide (FeO), ferric oxide (Fe₂O₃), or a combination thereof, but it is not limited thereto. In accordance with some embodiments, the particle size (particle diameter) of the magnetic oxide material source MO may be between 200 nanometers (nm) and 5 micrometers (μm), for example, between 300 nm and 4.8 μm, between 500 nm and 4.5 μm, between 800 nm and 4.2 μm, or between 1 μm and 4 μm. For example, the particle size of the magnetic oxide material source MO may be 250 nm, 350 nm, 450 nm, 550 nm, 650 nm, 750 nm, 850 nm, 950 nm, 1.2 μm, 1.5 μm, 1.8 μm, 2 μm, 2.3 μm, 2.5 μm, 2.7 μm, 3 μm, 3.25 μm, 3.5 μm, or 3.75 μm, but it is not limited thereto.

Furthermore, in accordance with some embodiments, the magnetic oxide material source supply unit 20 may directly provide a non-nanonized magnetic oxide material source MO, for example, a coarse material source of magnetic iron oxide. The step of nanonizing the magnetic oxide material source MO can be omitted so as to simplify the process and reduce costs. In particular, in accordance with some embodiments, the magnetic oxide material source MO may be a by-product from a steel plant (for example, a product generated by a pickling process (acid washing process)), thereby realizing the energy recovery of waste resources.

The ultrasonic treatment unit 30 is connected to the feed unit 10. The ultrasonic treatment unit 30 may be disposed downstream of the feed unit 10 and the magnetic oxide material source supply unit 20. The ultrasonic treatment unit 30 can ultrasonically treat the first organic liquid O1 including the magnetic oxide material source MO and organic wastewater WT to produce a second organic liquid O2 including magnetic nanoparticles P0 of different sizes and hydrolyzed sludge HS. In accordance with some embodiments, the feed unit 10 and the magnetic oxide material source supply unit 20 are respectively connected to the ultrasonic treatment unit 30 via a connector L.

In accordance with some embodiments, the output power of the ultrasonic treatment performed in the ultrasonic treatment unit 30 may be between 300 watts and 1200 watts, for example, between 350 watts and 1150 watts, or between 400 watts and 1100 watts, or for example, 450 watts, 500 watts, 550 watts, 600 watts, 650 watts, 700 watts, 750 watts, 800 watts, 900 watts, 950 watts, 1000 watts, or 1050 watts, but it is not limited thereto. In accordance with some embodiments, the frequency of the ultrasonic treatment performed in the ultrasonic treatment unit 30 may be between 20 kHz and 100 kHz, for example, between 20 kHz and 90 kHz, or between 25 kHz and 80 kHz, or for example, 25 kHz, 30 kHz, 35 kHz, 40 kHz, 45 kHz, 50 kHz, 55 kHz, 60 kHz, 65 kHz, 70 kHz, 75 kHz, 80 kHz, or 85 kHz, but it is not limited thereto.

It is worth noting that the magnetic oxide material source MO in coarse material form (having a particle size greater than 200 nanometers) may be used as an abrasive for ultrasonic treatment to enhance the sonochemical effect of the ultrasonic treatment on sludge destruction, thereby improving hydrolysis efficiency and increasing the yield of the hydrolyzed sludge HS. At the same time, the magnetic oxide material source MO subjected to multiple ultrasonic oscillations begins to fracture, forming magnetic nanoparticles P0 of different sizes with a normal distribution.

Furthermore, the separation unit 40 is connected to the ultrasonic treatment unit 30. The separation unit 40 may be disposed downstream of the ultrasonic treatment unit 30. The separation unit 40 can separate the magnetic nanoparticles P0 of different sizes into first magnetic nanoparticles P1 and second magnetic nanoparticles P2 according to particle size. The first magnetic nanoparticles P1 are recirculated upstream of the ultrasonic treatment unit 30 to be mixed with the first organic liquid O1, so as to continuously subject the first organic liquid O1 to ultrasonic treatment.

The first magnetic nanoparticles P1 and the second magnetic nanoparticles P2 are formed from the magnetic oxide material source MO by ultrasonic treatment. The first magnetic nanoparticles P1 and the second magnetic nanoparticles P2 also include magnetic iron oxide. In accordance with some embodiments, the magnetic iron oxide may include magnetite (Fe₃O₄), ferrous oxide (FeO), ferric oxide (Fe₂O₃), or a combination thereof, but it is not limited thereto. Specifically, the size of the first magnetic nanoparticles P1 may be larger than the size of the second magnetic nanoparticles P2. In accordance with some embodiments, the size of the first magnetic nanoparticles P1 may be between 200 nm and 5 μm, for example, between 300 nm and 4.8 μm, between 500 nm and 4.5 μm, between 800 nm and 4.2 μm, or between 1 μm and 4 μm. For example, the size of the first magnetic nanoparticles P1 may be 250 nm, 350 nm, 450 nm, 550 nm, 650 nm, 750 nm, 850 nm, 950 nm, 1.2 μm, 1.5 μm, 1.8 μm, 2 μm, 2.3 μm, 2.5 μm, 2.7 μm, 3 μm, 3.25 μm, 3.5 μm, or 3.75 μm, but it is not limited thereto. In accordance with some embodiments, the size of the second magnetic nanoparticles may be between 20 nm and 200 nm, for example, between 30 nm and 190 nm, or between 40 nm and 180 nm. For example, the size of the second magnetic nanoparticles may be 50 nm, 60 nm, 70 nm, 75 nm, 80 nm, 85 nm, 90 nm, 100 nm, 110 nm, 120 nm, 130 nm, 140 nm, 150 nm, 160 nm, or 170 nm, but it is not limited thereto.

In accordance with some embodiments, the separation unit 40 may be a gravity settling separation device or a magnetic adsorption separation device. It is noteworthy that the separation unit 40 may separate the coarser first magnetic nanoparticles P1 from the finer second magnetic nanoparticles P2, and recirculate the coarse first magnetic nanoparticles P1 (having a particle size greater than 200 nanometers) to the ultrasonic treatment unit 30 for continued use as an abrasive, while directing the fine second magnetic nanoparticles P2 (having a particle size smaller than 200 nanometers) together with the hydrolyzed sludge HS into the subsequent anaerobic biological treatment unit 50 as an accelerator for interspecies electron transfer (IET) in the anaerobic digestion reaction. This enhances extracellular electron transfer of microorganisms, alleviates the inhibition caused by high organic loading rate, organic acids, and toxic substances, and effectively degrades complex organic matter, overcoming the low electron transfer efficiency and acidification problems of conventional anaerobic digestion.

As described above, the first magnetic nanoparticles P1 are recirculated upstream of the ultrasonic treatment unit 30 to be mixed with the first organic liquid O1, so as to continuously subject the first organic liquid O1 to ultrasonic treatment. The second magnetic nanoparticles P2 are then transferred to the anaerobic biological treatment unit 50 for further anaerobic biological treatment. In accordance with some embodiments, the ultrasonic treatment unit 30 and the separation unit 40 are connected by connectors L. Specifically, in accordance with some embodiments, the ultrasonic treatment unit 30 is disposed upstream of the separation unit 40, and the separation unit 40 has a connector L (for convenience, labeled as connector L1) connected to the downstream side of the ultrasonic treatment unit 30. Furthermore, in accordance with some embodiments, the separation unit 40 further has a connector L (for convenience, labeled as connector L2) connected to the upstream side of the ultrasonic treatment unit 30 and a connector L (for convenience, labeled as connector L3) connected to the upstream side of the anaerobic biological treatment unit 50.

The anaerobic biological treatment unit 50 is connected to the separation unit 40. The anaerobic biological treatment unit 50 may be disposed downstream of the separation unit 40. The second magnetic nanoparticles P2 can enhance the microorganisms in the anaerobic biological treatment unit 50 to perform anaerobic biological treatment on the hydrolyzed sludge HS, thereby converting it into methane MT. The methane MT can then be provided to a subsequent biogas power generation facility for conversion into electrical energy. Specifically, anaerobic biological treatment can decompose and convert small organic molecules into biogas, such as methane, through microbial biochemical metabolism. In accordance with some embodiments, the anaerobic biological treatment unit 50 can include an anaerobic fermentation tank, which may include hydrolytic bacteria, acidogenic bacteria (acid-forming bacteria), methanogens, another suitable bacterial strain, or a combination thereof, but it is not limited thereto.

In accordance with some embodiments, the anaerobic biological treatment may be performed at a temperature between 25°C and 45°C, for example, between 27°C and 42°C, or between 30°C and 40°C, or, for example, at 31°C, 32°C, 33°C, 34°C, 35°C, 36°C, 37°C, 38°C, or 39°C, but it is not limited thereto. In accordance with some embodiments, the anaerobic biological treatment may be performed at a pH between 6.8 and 7.2, for example, at pH 6.9, pH 7, or pH 7.1, but it is not limited thereto.

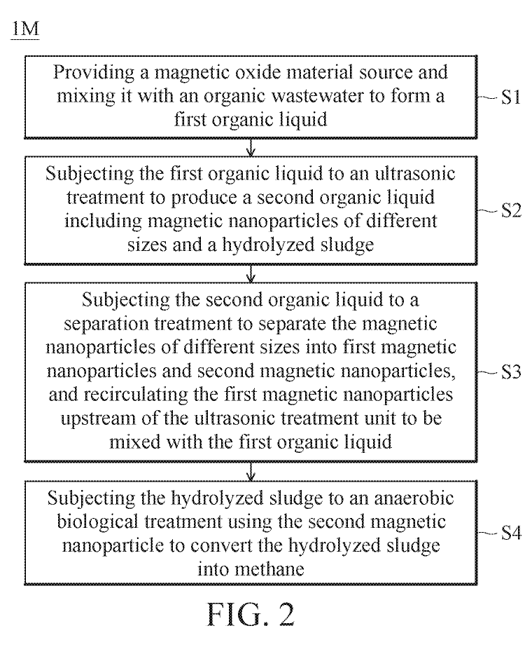

In addition, the present disclosure also provides a method for treating organic wastewater 1M. Please refer to FIG. 2, which shows a flow chart of the steps of the method for treating organic wastewater 1M in accordance with some embodiments of the present disclosure. In accordance with some embodiments, the method for treating organic wastewater 1M includes treating organic waste using the aforementioned organic wastewater treatment system 1S, but the present disclosure is not limited thereto. It should be understood that, in accordance with some embodiments, additional steps may be added before, during, or after the method for treating organic wastewater 1M described below, or some steps may be replaced or omitted.

As shown in FIG. 2, the method for treating organic wastewater 1M includes step S1: providing a magnetic oxide material source MO and mixing it with organic wastewater WT to form a first organic liquid O1 including the magnetic oxide material source MO and the organic wastewater WT.

The first organic liquid O1 may be a homogeneous organic liquid formed by mixing the magnetic oxide material source MO and the organic wastewater WT. In accordance with some embodiments, the weight volume percentage (w/v) of the magnetic oxide material source MO to the organic wastewater WT may be between 0.01% and 1%, for example, between 0.05% and 1%, or between 0.1% and 1%. For example, the weight volume percentage (w/v) of the magnetic oxide material source MO to the organic wastewater WT may be 0.01%, 0.02%, 0.03%, 0.05%, 0.08%, 0.1%, 0.2%, 0.3%, 0.5%, 0.75%, 0.85%, or 1%, but it is not limited thereto. It is worth noting that when the weight volume percentage (w/v) of the magnetic oxide material source MO to the organic wastewater WT is within the above range, the efficiency of subsequent ultrasonic treatment and anaerobic biological treatment can be effectively improved. For example, the overall digestion rate of the organic sludge can be increased, thereby shortening the digestion time of the organic sludge and increasing the biogas methane production rate.

The magnetic oxide material source MO includes magnetic iron oxide. In accordance with some embodiments, the magnetic iron oxide may include magnetite (Fe₃O₄), ferrous oxide (FeO), ferric oxide (Fe₂O₃), or a combination thereof, but it is not limited thereto. In accordance with some embodiments, the particle size (particle diameter) of the magnetic oxide material source MO may be between 200 nanometers (nm) and 5 micrometers (μm), for example, between 300 nm and 4.8 μm, between 500 nm and 4.5 μm, between 800 nm and 4.2 μm, or between 1 μm and 4 μm. For example, the particle size of the magnetic oxide material source MO may be 250 nm, 350 nm, 450 nm, 550 nm, 650 nm, 750 nm, 850 nm, 950 nm, 1.2 μm, 1.5 μm, 1.8 μm, 2 μm, 2.3 μm, 2.5 μm, 2.7 μm, 3 μm, 3.25 μm, 3.5 μm, or 3.75 μm, but it is not limited thereto.

In accordance with some embodiments, the magnetic oxide material source MO may be a coarse material source of magnetic iron oxide. The step of pre-nanonizing the magnetic oxide source MO can be omitted so as to simplify the process and reduce costs. In particular, in accordance with some embodiments, the magnetic oxide material source MO may be a by-product from a steel plant (for example, a product generated by a pickling process (acid washing process)), thereby realizing the energy recovery of waste resources.

The organic wastewater WT includes organic sludge. In accordance with some embodiments, the organic wastewater WT may include wastewater from the food industry, manufacturing industry, petrochemical industry, agriculture, livestock industry, wastewater containing organic matter from other sources, or a combination thereof, but it is not limited thereto.

Furthermore, the method for treating organic wastewater 1M includes step S2: subjecting the first organic liquid O1 to an ultrasonic treatment to produce a second organic liquid O2 including magnetic nanoparticles P0 of different sizes and a hydrolyzed sludge HS. Specifically, when ultrasound is used to hydrolyze the liquid containing organic matter, the impact force generated by the cavitation effect destroys the outer layer (e.g., cell wall) of the organic sludge, thereby releasing the organic matter in the organic sludge and increasing the concentration of dissolved organic matter in the organic liquid.

In accordance with some embodiments, the output power of the ultrasonic treatment may be between 300 watts and 1200 watts, for example, between 350 watts and 1150 watts, or between 400 watts and 1100 watts. For example, the output power of the ultrasonic treatment may be 450 watts, 500 watts, 550 watts, 600 watts, 650 watts, 700 watts, 750 watts, 800 watts, 900 watts, 950 watts, 1000 watts or 1050 watts, but it is not limited thereto. In accordance with some embodiments, the frequency of the ultrasonic treatment may be between 20 kHz and 100 kHz, for example, between 20 kHz and 90 kHz, or between 25 kHz and 80 kHz. For example, the frequency of the ultrasonic treatment may be 25 kHz, 30 kHz, 35 kHz, 40 kHz, 45 kHz, 50 kHz, 55 kHz, 60 kHz, 65 kHz, 70 kHz, 75 kHz, 80 kHz, or 85 kHz, but it is not limited thereto. Furthermore, in accordance with some embodiments, the ultrasonic treatment may be performed for between 1 minute and 20 minutes, for example, 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, or 19 minutes, but it is not limited thereto.

It is worth noting that the magnetic oxide material source MO in coarse material form (having a particle size greater than 200 nanometers) may be used as an abrasive for ultrasonic treatment to enhance the sonochemical effect of the ultrasonic treatment on sludge destruction, thereby improving hydrolysis efficiency and increasing the yield of the hydrolyzed sludge HS. At the same time, the magnetic oxide material source MO subjected to multiple ultrasonic oscillations begins to fracture, forming magnetic nanoparticles P0 of different sizes with a normal distribution.

Furthermore, the method for treating organic wastewater 1M includes step S3: subjecting the second organic liquid O2 to a separation treatment to separate the magnetic nanoparticles P0 of different sizes into first magnetic nanoparticles P1 and second magnetic nanoparticles P2 according to particle size. The first magnetic nanoparticles P1 are recirculated upstream of the ultrasonic treatment unit 30 to be mixed with the first organic liquid O1, so as to continuously subject the first organic liquid O1 to ultrasonic treatment.

The magnetic oxide material source MO is ultrasonically treated to form first magnetic nanoparticles P1 and second magnetic nanoparticles P2. The first magnetic nanoparticles P1 and the second magnetic nanoparticles P2 also include magnetic iron oxide. In accordance with some embodiments, the magnetic iron oxide may include magnetite (Fe₃O₄), ferrous oxide (FeO), ferric oxide (Fe₂O₃), or a combination thereof, but it is not limited thereto. Specifically, the size of the first magnetic nanoparticles P1 may be larger than the size of the second magnetic nanoparticles P2. In accordance with some embodiments, the size of the first magnetic nanoparticles P1 may be between 200 nm and 5 μm, for example, between 300 nm and 4.8 μm, between 500 nm and 4.5 μm, between 800 nm and 4.2 μm, or between 1 μm and 4 μm. For example, the size of the first magnetic nanoparticles P1 may be 250 nm, 350 nm, 450 nm, 550 nm, 650 nm, 750 nm, 850 nm, 950 nm, 1.2 μm, 1.5 μm, 1.8 μm, 2 μm, 2.3 μm, 2.5 μm, 2.7 μm, 3 μm, 3.25 μm, 3.5 μm, or 3.75 μm, but it is not limited thereto. In accordance with some embodiments, the size of the second magnetic nanoparticles may be between 20 nm and 200 nm, for example, between 30 nm and 190 nm, or between 40 nm and 180 nm. For example, the size of the second magnetic nanoparticles may be 50 nm, 60 nm, 70 nm, 75 nm, 80 nm, 85 nm, 90 nm, 100 nm, 110 nm, 120 nm, 130 nm, 140 nm, 150 nm, 160 nm, or 170 nm, but it is not limited thereto.

In accordance with some embodiments, the separation treatment may be a gravity settling separation treatment or a magnetic adsorption separation treatment. It is noteworthy that the separation treatment may separate the coarser first magnetic nanoparticles P1 from the finer second magnetic nanoparticles P2, and recirculate the coarse first magnetic nanoparticles P1 (having a particle size greater than 200 nanometers) to be mixed with the first organic liquid O1 for ultrasonic treatment and continued use as an abrasive, while directing the fine second magnetic nanoparticles P2 (having a particle size smaller than 200 nanometers) together with the hydrolyzed sludge HS into the subsequent anaerobic biological treatment (step S4) as an accelerator for interspecies electron transfer (IET) in the anaerobic digestion reaction. This enhances extracellular electron transfer of microorganisms, alleviates the inhibition caused by high organic loading rate, organic acids, and toxic substances, and effectively degrades complex organic matter, overcoming the low electron transfer efficiency and acidification problems of conventional anaerobic digestion.

Furthermore, the method for treating organic wastewater 1M may include step S4: subjecting the hydrolyzed sludge HS to an anaerobic biological treatment using the second magnetic nanoparticle P2 to convert the hydrolyzed sludge HS into methane MT. The methane MT can then be provided to a subsequent biogas power generation facility for conversion into electrical energy. Specifically, anaerobic biological treatment can decompose and convert small organic molecules into biogas, such as methane, through microbial biochemical metabolism. In accordance with some embodiments, the anaerobic biological treatment can include the use of hydrolytic bacteria, acidogenic bacteria, methanogens, another suitable bacterial strain, or a combination thereof, but it is not limited thereto. As mentioned above, the second magnetic nanoparticles P2 can serve as an interspecies electron transfer (IET) accelerator to improve the efficiency of anaerobic biological treatment.

In accordance with some embodiments, the anaerobic biological treatment may be performed at a temperature between 25°C and 45°C, for example, between 27°C and 42°C, or between 30°C and 40°C, or for example, at 31°C, 32°C, 33°C, 34°C, 35°C, 36°C, 37°C, 38°C, or 39°C, but it is not limited thereto. In accordance with some embodiments, the anaerobic biological treatment may be performed at a pH between 6.8 and 7.2, for example, at pH 6.9, pH 7, or pH 7.1, but it is not limited thereto.

In addition, in accordance with some embodiments, the method for treating organic wastewater 1M includes continuously performing steps S2 to S4 at least 5 to 20 times. For example, the cycle of steps S2 to S4 can be continuously performed 6, 7, 8, 9, 10, 11, 12, 13, 14, 15, 16, 17, 18, or 19 times, but it is not limited thereto.

In order to make the above-mentioned and other purposes, features and advantages of the present disclosure more thorough and easy to understand, a number of examples are given below, and are described in detail as follows, but they are not intended to limit the scope of the present disclosure.

### EXAMPLES

Example 1 - Effect of a ddition of m agnetic oxide material source on u ltrasonic t reatment e fficiency

Magnetic iron oxide was used as a magnetic oxide material source and as an abrasive added to an ultrasonic treatment unit for sludge pretreatment. Specifically, waste organic matter (organic wastewater from a manufacturing wastewater plant containing approximately 5% biological sludge) is mixed with magnetic iron oxide (commercially available coarse source (200nm-5µm) magnetic iron oxide (Fe₃O₄) particle powder) to form a homogeneous organic liquid (the weight/volume percentage (w/v) of magnetic iron oxide to waste organic matter ranges from 0.01% to 1%). This organic liquid is then subjected to ultrasonic treatment at an output power range of 300 watts to 1200 watts and a frequency range of 20 kHz to 100 kHz. Following the reaction, the chemical oxygen demand (COD) concentration of the ultrasonically treated hydrolyzate is measured to assess the effectiveness of the pretreatment of the waste organic matter. COD concentration is an indicator of the effectiveness of pretreatment of the waste organic matter prior to anaerobic biological treatment, typically representing the concentration of organic matter in the liquid (expressed in mg/L).

Specifically, in this experiment, 3000 ml of organic wastewater containing organic sludge (waste organic matter) with a suspended solids (SS) concentration of approximately 50,185 mg/L and a volatile suspended solids (VSS) concentration of approximately 36,625 mg/L was taken and divided into six equal portions, each containing 500 ml. Subsequently, coarse source magnetic iron oxide (Fe₃O₄) particle powder was added to each portion, such that the magnetic iron oxide concentrations (weight/volume percentage of magnetic iron oxide to waste organic matter (w/v)) in the six portions were 0%, 0.01%, 0.05%, 0.1%, 0.5%, and 1%, respectively. After mixing, the mixture was ultrasonically treated at a frequency of 20 kHz and a power of 500 watts for 5 minutes, and the changes in dissolved organic matter concentration were measured.

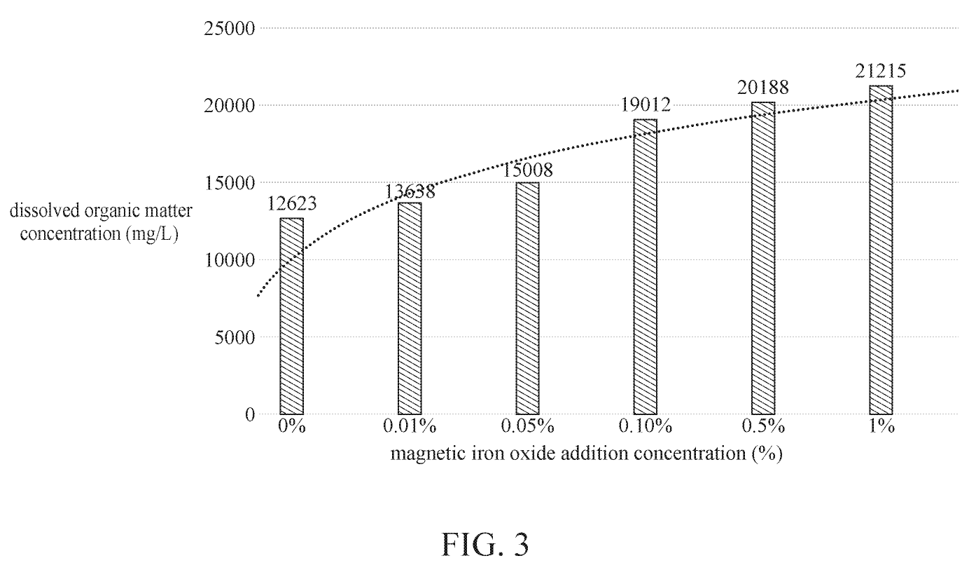

The test results are shown in FIG. 3. From left to right, the six reaction samples were added with a magnetic iron oxide material source (Fe₃O₄) at concentrations of 0%, 0.01%, 0.05%, 0.1%, 0.5%, and 1%. The dissolved organic matter concentrations measured after ultrasonic treatment were approximately 12,623 mg/L, approximately 13,638 mg/L, approximately 15,008 mg/L, approximately 19,012 mg/L, approximately 20,188 mg/L, and approximately 21,215 mg/L, respectively. The test results show that the efficiency of ultrasonic treatment increases with the increase in the concentration of magnetic iron oxide added as an abrasive. Specifically, compared to the group without addition of magnetic iron oxide (magnetic iron oxide addition concentration of 0%), under the condition of a routine addition concentration of 0.1% magnetic iron oxide in wastewater treatment, the concentration of dissolved organic matter can be significantly increased by about 51%. At a magnetic iron oxide addition concentration of 1%, the concentration of dissolved organic matter can be greatly increased by about 68%.

Example 2 - Effect of a dding m agnetic oxide material source on u ltrasonic t reatment e fficiency

According to the method described in Example 1, the waste organic matter to be treated was divided into two portions. One portion did not contain magnetic iron oxide, and the other portion was added with a coarse source of magnetic iron oxide (Fe₃O₄) particle powder to a concentration of 0.1%. After mixing, the two portions were subjected to the ultrasonic treatment at a frequency of 20 kHz and a power of 500 watts for 0 to 15 minutes. Then, the changes in dissolved organic matter (COD) concentration after 0 to 15 minutes of ultrasonic treatment were measured.

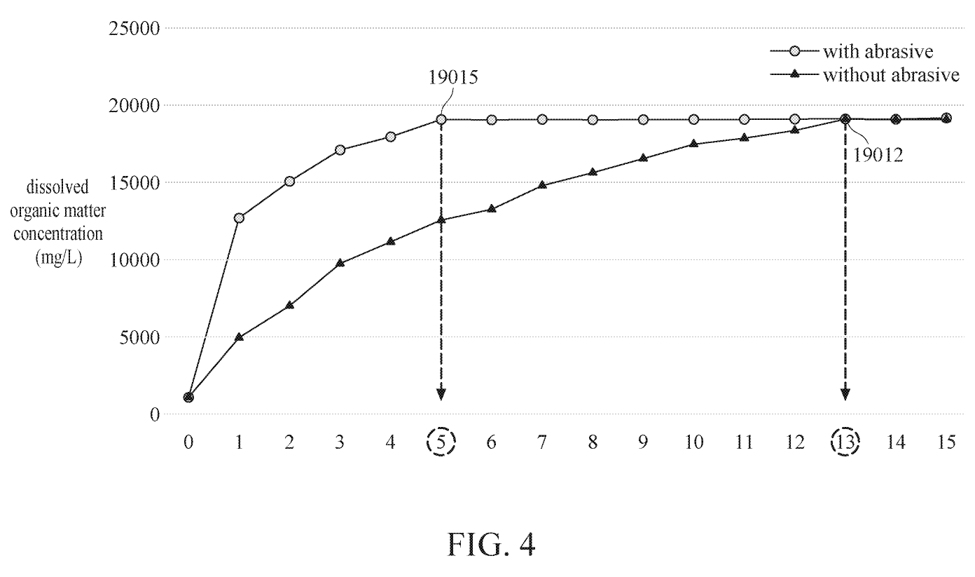

The test results are shown in FIG. 4. Under the same reaction conditions, magnetic iron oxide particles were added as an abrasive for ultrasonic hydrolysis treatment of organic sludge. Compared with ultrasonic hydrolysis treatment of organic sludge without the addition of magnetic iron oxide, the results show that, to reach a peak concentration of soluble organic matter (COD) of approximately 19,000 mg/L, the group without magnetic iron oxide addition (shown as “without abrasive”) requires 13 minutes of treatment, whereas the group with 0.1% magnetic iron oxide addition (shown as “with abrasive”) requires only 5 minutes of treatment. Furthermore, using the attainment of the COD peak as the completion of one reaction and calculating the power consumption based on 8.3 W per minute of treatment, the group without magnetic iron oxide addition consumes 107.9 W, while the group with magnetic iron oxide addition consumes only 41.5 W. The results indicate that the group with magnetic iron oxide particles added as an abrasive can enable the ultrasonic treatment unit to save at least about 62% of energy consumption.

Example 3 - Analysis of the e ffect of u ltrasonic t reatment u nit on the particle nanonization of m agnetic i ron o xide material s ource ( Effect of u ltrasonic t reatment t ime and effect of w astewater s ludge c oncentration)

According to the method described in Example 1, the organic waste to be treated was divided into four portions, each portion having coarse magnetic iron oxide (Fe₃O₄) particle powder added at a concentration of 0.1%. After mixing, each portion was subjected to ultrasonic treatment at a frequency of 20 kHz and a power of 500 watts for 0 minutes, 2.5 minutes, 5 minutes, and 10 minutes, respectively. The proportion change in particle size distribution of the magnetic iron oxide (Fe₃O₄) particles contained in the hydrolyzed sludge produced after the ultrasonic treatment was then measured.

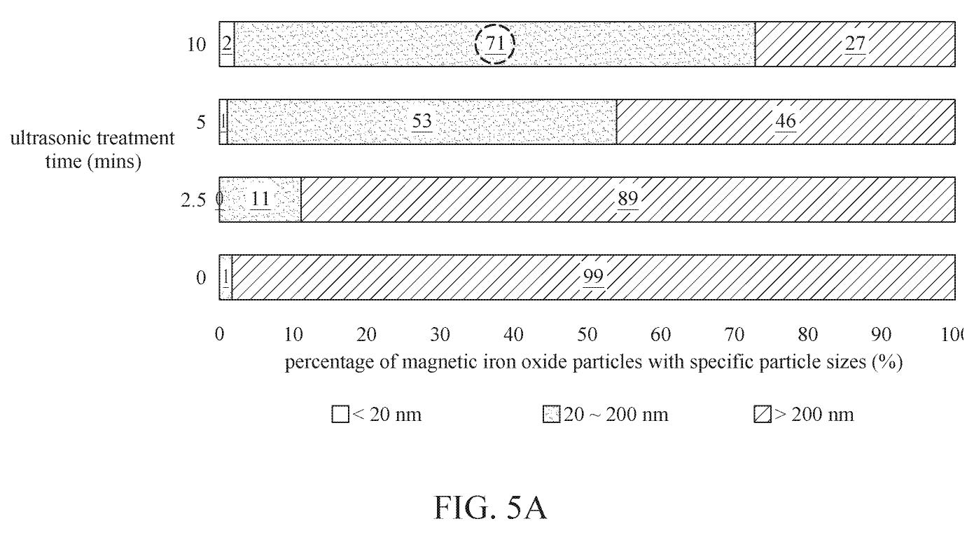

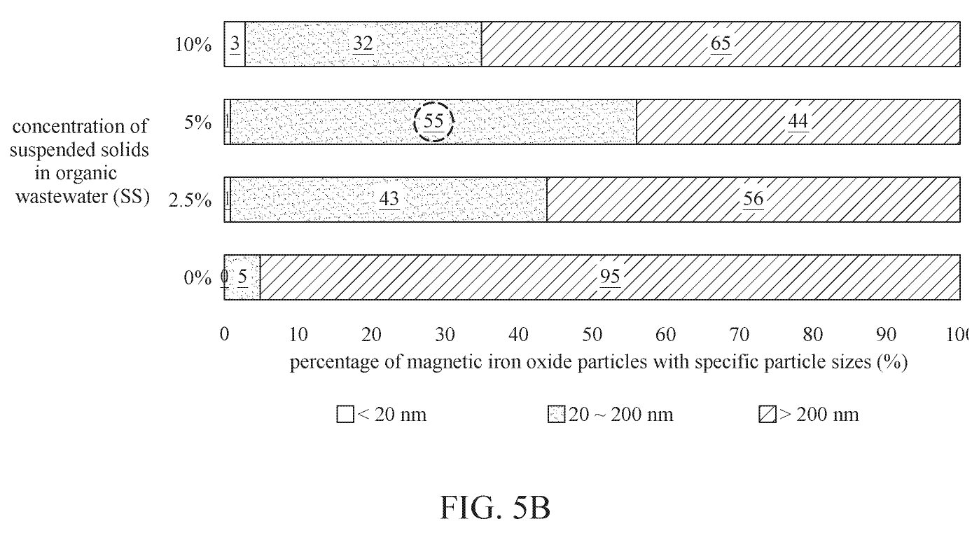

The test results are shown in FIG. 5A. The results indicate that the magnetic iron oxide (Fe₃O₄) underwent nanonization after ultrasonic treatment. The particle sizes were categorized into three ranges: less than 20 nm (< 20 nm), between 20nm and 200nm (20-200 nm), and greater than 200 nm (> 200 nm). Observing the proportion distribution of each particle size range after ultrasonic treatment, the formation of particles in the 20-200 nm size range was used as a reference indicator of nanonization. The results show that after 10 minutes of ultrasonic treatment, nanonization of the magnetic iron oxide was evident, with the proportion of particles in the 20-200 nm size range reaching at least about 71%. In addition, the numerical values in the figure indicate that in the ultrasonic sludge pretreatment reaction, the nanonization of the coarse magnetic iron oxide material source increased with the ultrasonic treatment time.

Furthermore, according to the method described in Example 1, four portions of organic wastewater containing 0%, 2.5%, 5%, and 10% biological sludge (suspended solids), respectively, were prepared. Each portion had coarse magnetic iron oxide (Fe₃O₄) particle powder added at a concentration of 0.1%. After mixing, each portion was subjected to ultrasonic treatment at a frequency of 20 kHz and a power of 500 watts for 5 minutes. The proportion change in particle size distribution of the magnetic iron oxide (Fe₃O₄) particles contained in the hydrolyzed sludge produced after the ultrasonic treatment was then measured.

The test results are shown in FIG. 5B. The results indicate that the magnetic iron oxide (Fe₃O₄) underwent nanonization after ultrasonic treatment. The particle sizes were categorized into three ranges: less than 20 nm (< 20 nm), between 20 nm and 200 nm (20-200 nm), and greater than 200 nm (> 200 nm). Observing the proportion distribution of each particle size range after ultrasonic treatment, the formation of particles in the 20-200 nm size range was used as a reference indicator of nanonization. The results show that for organic wastewater containing 5% biological sludge, nanonization of the magnetic iron oxide was evident, with the proportion of particles in the 20-200 nm size range reaching at least about 55%. In addition, the numerical values in the figure indicate that in the ultrasonic sludge pretreatment reaction, the nanonization of the coarse magnetic iron oxide material source increased with increasing wastewater sludge concentration when the biological sludge content was 5% or less. However, when the biological sludge content exceeded 5%, the nanonization degree of the magnetic iron oxide could no longer be increased. In fact, the nanonization degree (based on the proportion of particles in the 20-200 nm size range) at a biological sludge content of 10% was lower than that at 5%.

Example 4 - Analysis of the e ffect of n anosized m agnetic i ron o xide on m ethane y ield in a naerobic b iological t reatment u nit ( e ffect of m agnetic i ron o xide particle s ize and e ffect of m agnetic i ron o xide addition amount )

The methane production test included the following steps: The test was divided into four groups, each prepared in an identical 600 ml reaction tank. The reaction tanks either without magnetic iron oxide addition (Fe₃O₄) or contained the same concentration (0.01%) of magnetic iron oxide (Fe₃O₄) having different particle sizes, specifically less than 20 nm (< 20 nm), between 20 nm and 200 nm (20-200 nm), and greater than 200 nm (> 200 nm). Each group was provided with 350 ml of organic hydrolyzed sludge substrate and 150 ml of well-mixed seed sludge. The reaction conditions were set at 35°C and pH 7.0, and batch anaerobic digestion tests were conducted. A gas collection port was installed at the top of each reaction tank lid, and a gas flow meter was used to collect methane gas generated from the decomposition of the organic hydrolyzed sludge. The reactions were carried out under continuous stirring for more than 7 days, and the cumulative gas production of each test sample was recorded.

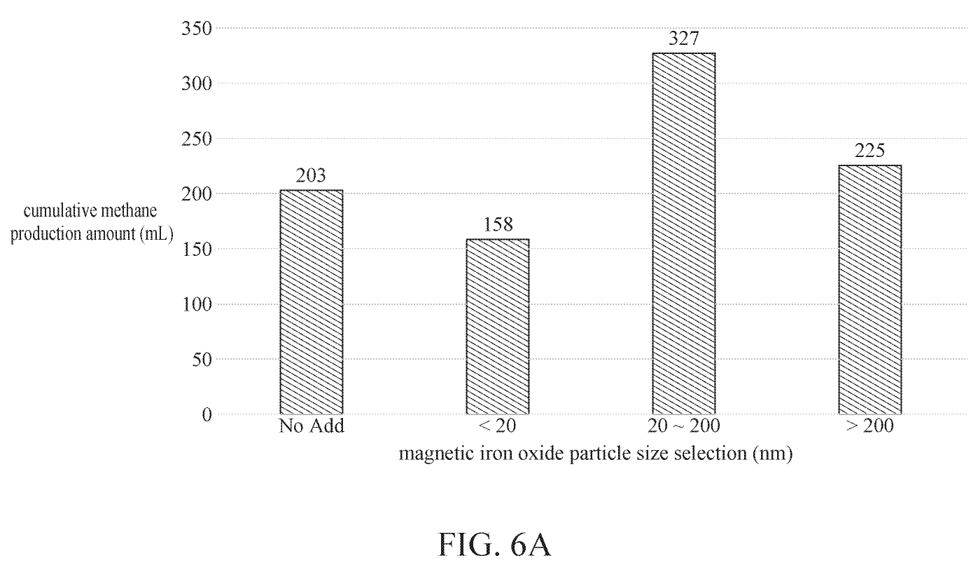

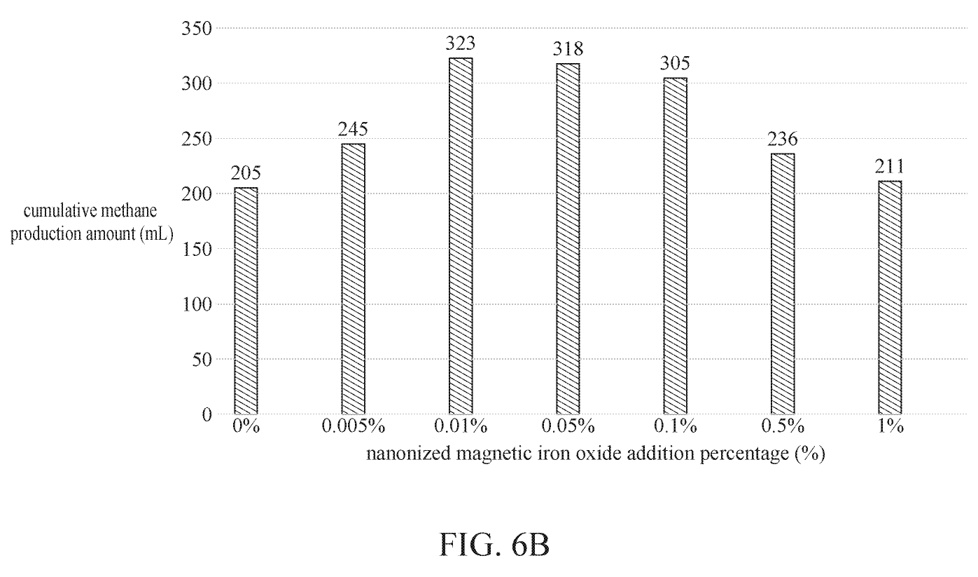

The test results are shown in FIG. 6A. The cumulative methane production of the four test samples was 203 ml, 158 ml, 327 ml, and 225 ml, respectively. Compared with the group without magnetic iron oxide addition (No Add), the groups with magnetic iron oxide of particle sizes 20-200 nm and greater than 200 nm showed increases in methane production of 61% and 11%, respectively, while the group with magnetic iron oxide of particle size less than 20 nm showed a decrease of 22%. These results indicate that in the anaerobic biological unit of wastewater treatment, adding magnetic iron oxide with a particle size of 20-200 nm can significantly increase methane yield by up to 1.6 times. In other words, adding nanonized magnetic iron oxide of a specific particle size (20-200 nm) can serve as an interspecies electron transfer (IET) accelerator, effectively increasing methane production.

Furthermore, according to the aforementioned test method and under the same reaction conditions, magnetic iron oxide with a particle size of 20-200 nm was added at different amounts, namely 0%, 0.005%, 0.01%, 0.05%, 0.1%, 0.5%, and 1%, for a total of seven groups. After anaerobic biological reaction, the cumulative gas production of each test sample was recorded to observe the effect of the addition amount of 20-200 nm magnetic iron oxide on methane yield.

The test results are shown in FIG. 6B. The cumulative methane production of the seven test samples with 0%, 0.005%, 0.01%, 0.05%, 0.1%, 0.5%, and 1% magnetic iron oxide addition was 205 ml, 245 ml, 323 ml, 318 ml, 305 ml, 236 ml, and 211 ml, respectively. Compared with the group without magnetic iron oxide addition (0%), adding nanonized magnetic iron oxide of specific amounts (0.005%-0.1%) as an interspecies electron transfer (IET) accelerator can effectively increase methane production, with the 0.01% addition amount group showing the most significant increase of at least about 58%.

Example 5 - Overall effect of a dding m agnetic i ron o xide material s ource on m ethane y ield of the o rganic w astewater t reatment s ystem

According to the ultrasonic treatment method described in Example 1, combined with the anaerobic biological treatment method described in Example 4, magnetic iron oxide was introduced into the wastewater treatment process to observe its overall effect on converting organic wastewater into methane in the organic wastewater treatment system. Using the optimal application parameters demonstrated in the above examples, 0.1% magnetic iron oxide (Fe₃O₄, 200 nm-5 µm) was added to the ultrasonic treatment unit, and 0.01% magnetic iron oxide (Fe₃O₄, 20-200 nm) was introduced into the anaerobic biological treatment unit. After reaction in the organic wastewater treatment system, the final methane production and production rate were measured to evaluate the overall efficiency of converting organic matter into methane.

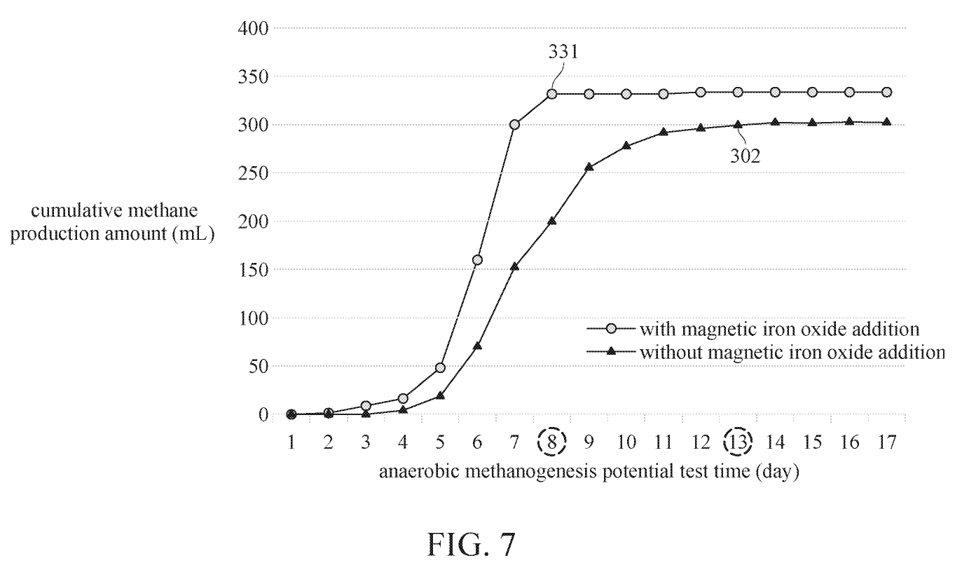

The measured results are shown in FIG. 7. In the group without magnetic iron oxide addition, the cumulative gas production peak was reached after 13 days of reaction in the organic wastewater treatment system, with a total gas production of about 302 L. In contrast, the group with magnetic iron oxide addition reached the peak after only 8 days, with a total gas production of about 331 L. Compared with the group without magnetic iron oxide addition, the group with magnetic iron oxide addition showed improvement in both production quantity and production rate. These results demonstrate that the magnetic iron oxide material source can play a dual role as both an abrasive and an interspecies electron transfer accelerator in the wastewater treatment system. The addition of magnetic iron oxide can increase methane production by at least about 10% and increase the production rate by at least about 1.8 times.

To summarize the above, embodiments of the present disclosure provide an organic wastewater treatment method capable of simultaneously improving sludge pretreatment efficiency and methane yield. By adding a magnetic oxide material source and combining it with the scheduling of the wastewater treatment process, the oxide coarse material source serves as an ultrasonic abrasive and as a biochemical metabolic catalyst at different stages of wastewater treatment. This synergistically enhances the existing ultrasonic sludge hydrolysis technology and the subsequent anaerobic biological metabolism for organic matter conversion, thereby achieving the effect of simultaneously improving sludge pretreatment efficiency and methane yield, and enabling the treatment of organic wastewater in a more energy-efficient and effective manner.

Although some embodiments of the present disclosure and their advantages have been described as above, it should be understood that various changes, substitutions and alterations can be made herein without departing from the spirit and scope of the disclosure as defined by the appended claims. In addition, each claim constitutes an individual embodiment, and the claimed scope of the present disclosure also includes the combinations of the claims and embodiments. The scope of protection of the present disclosure is subject to the definition of the scope of the appended claims.

What is claimed is:

1. A method for treating organic wastewater, comprising:
(a) providing a magnetic oxide material source and mixing the magnetic oxide material source with an organic wastewater to form a first organic liquid comprising the magnetic oxide material source and the organic wastewater;
(b) subjecting the first organic liquid to an ultrasonic treatment to produce a second organic liquid comprising magnetic nanoparticles of different sizes and a hydrolyzed sludge;
(c) subjecting the second organic liquid to a separation treatment to separate the magnetic nanoparticles of different sizes into first magnetic nanoparticles and second magnetic nanoparticles according to particle size, wherein the first magnetic nanoparticles are recirculated to be mixed with the first organic liquid to continuously subject the first organic liquid to the ultrasonic treatment; and
(d) subjecting the hydrolyzed sludge to an anaerobic biological treatment using the second magnetic nanoparticles to convert the hydrolyzed sludge into methane,
wherein the magnetic oxide material source, the first magnetic nanoparticles, and the second magnetic nanoparticles each comprise at least magnetic iron oxide.

2. The method for treating organic wastewater as claimed in claim 1, wherein the particle size of the magnetic oxide material source is between 200 nanometers and 5 micrometers.

3. The method for treating organic wastewater as claimed in claim 1, wherein the particle size of the first magnetic nanoparticles is between 200 nanometers and 5 micrometers, and the particle size of the second magnetic nanoparticles is between 20 nanometers and 200 nanometers.

4. The method for treating organic wastewater as claimed in claim 1, wherein the organic wastewater comprises wastewater from the food industry, manufacturing industry, petrochemical industry, agriculture, livestock industry, or a combination thereof.

5. The method for treating organic wastewater as claimed in claim 1, wherein in step (a), the weight/volume percentage (w/v) of the magnetic oxide material source to the organic wastewater is between 0.01% and 1%.

6. The method for treating organic wastewater as claimed in claim 1, wherein in step (b), an output power of the ultrasonic treatment is between 300 watts and 1200 watts, and a frequency of the ultrasonic treatment is between 20 kHz and 100 kHz.

7. The method for treating organic wastewater as claimed in claim 6, wherein the ultrasonic treatment is performed for between 1 minute and 20 minutes.

8. The method for treating organic wastewater as claimed in claim 1, wherein in step (d), the anaerobic biological treatment is performed at a temperature between 25°C and 45°C and at a pH between 6.8 and 7.2.

9. The method for treating organic wastewater as claimed in claim 1, wherein in step (d), the anaerobic biological treatment comprises using hydrolytic bacteria, acidogenic bacteria, methanogens, or a combination thereof.

10. The method for treating organic wastewater as claimed in claim 1, further comprising continuously performing steps (b) to (d) from 5 to 20 times.

11. The method for treating organic wastewater as claimed in claim 1, wherein the separation treatment is a gravity settling separation treatment or a magnetic adsorption separation treatment.

12. The method for treating organic wastewater as claimed in claim 1, wherein the magnetic iron oxide comprises magnetite (Fe₃O₄), ferrous oxide (FeO), ferric oxide (Fe₂O₃), or a combination thereof.

13. An organic wastewater treatment system, comprising:
a feed unit for providing organic wastewater;
a magnetic oxide material source supply unit connected to the feed unit for providing a magnetic oxide material source to be mixed with the organic wastewater to form a first organic liquid comprising the magnetic oxide material source and the organic wastewater;
an ultrasonic treatment unit connected to the feed unit for subjecting the first organic liquid to an ultrasonic treatment to produce a second organic liquid comprising magnetic nanoparticles of different sizes and a hydrolyzed sludge;
a separation unit connected to the ultrasonic treatment unit for separating the magnetic nanoparticles of different sizes into first magnetic nanoparticles and second magnetic nanoparticles according to particle size, wherein the first magnetic nanoparticles are recirculated upstream of the ultrasonic treatment unit to be mixed with the first organic liquid to continuously subject the first organic liquid to the ultrasonic treatment; and
an anaerobic biological treatment unit connected to the separation unit, wherein the second magnetic nanoparticles in the anaerobic biological treatment unit are used for subjecting the hydrolyzed sludge to an anaerobic biological treatment to convert the hydrolyzed sludge into methane,
wherein the magnetic oxide material source, the first magnetic nanoparticles, and the second magnetic nanoparticles each comprise at least magnetic iron oxide.

14. The organic wastewater treatment system as claimed in claim 13, wherein the ultrasonic treatment unit is disposed upstream of the separation unit, and the separation unit comprises a first connector connected downstream of the ultrasonic treatment unit.

15. The organic wastewater treatment system as claimed in claim 13, wherein the separation unit further comprises a second connector connected upstream of the ultrasonic treatment unit and a third connector connected upstream of the anaerobic biological treatment unit.

16. The organic wastewater treatment system as claimed in claim 13, wherein the organic wastewater comprises wastewater from the food industry, manufacturing industry, petrochemical industry, agriculture, livestock industry, or a combination thereof.

17. The organic wastewater treatment system as claimed in claim 13, wherein the particle size of the magnetic oxide material source is between 200 nanometers and 5 micrometers.

18. The organic wastewater treatment system as claimed in claim 13, wherein an output power of the ultrasonic treatment is between 300 watts and 1200 watts, and a frequency of the ultrasonic treatment is between 20 kHz and 100 kHz.

19. The organic wastewater treatment system as claimed in claim 13, wherein the anaerobic biological treatment is performed at a temperature between 25°C and 45°C and at a pH between 6.8 and 7.2.

20. The organic wastewater treatment system as claimed in claim 13, wherein the anaerobic biological treatment unit comprises an anaerobic fermentation tank, and the anaerobic fermentation tank comprises hydrolytic bacteria, acidogenic bacteria, methanogens, or a combination thereof.
